(19) United States
(12) Patent Application Publication
(10) Pub. No.: US 2005/0061410 A1
(43) Pub. Date: Mar. 24, 2005

(54) Pneumatic vehicle tire

(76) Inventors: Andreas Meyer, Garbsen (DE); Jurgen Sommer, Wedemark (DE)

Correspondence Address: SMITH, GAMBRELL & RUSSELL, LLP;SUITE 3100, PROMENADE II, 1230 PEACHTREE STREET, N.E., ATLANTA, GA, 30309-3592, US

(21) Appl. No.: 10/977,817

(22) Filed: Oct. 29, 2004

Related U.S. Application Data
(63) Continuation of application No. 09/668,292, filed on Sep. 25, 2000, now abandoned.

(30) Foreign Application Priority Data
Sep. 24, 1999 (DE) 199 45 774.3

(51) Int. Cl. B60C 11/00; B60C 3/00

(52) U.S. Cl. 152/209.14

(57) ABSTRACT

A pneumatic vehicle tire of the radial type with a tread strip, which has a width defined as the tread width TW, which represents its maximal width in the ground contact area in the case of mounted, loaded and inflated tires, where, when viewed in cross section, the outer contour of the tread strip has at least three different radii over its width TW, of which the first radius TR₁ extends over an area encompassing the zenith of the tire, while an adjoining area on both sides of this area has a radius TR₂, which is smaller than the radius TR₁, and while on each side of this area an adjoining area has a radius TRA, which is smaller than the radius TR₁ of the area encompassing the zenith of the tire. In each case, the edges of the tread strip defined by the tread width TW run in an area with a fourth radius, a shoulder radius provided in the transition area to the sidewalls of the tire. The radius TRA is determined according to the equation 0.05 TR₁≦TRA≦0.65 TR₁. The radius TR₂ can be either less than or greater than the radius TRA, where, for the case TR₂≦TRA, the radius TR₂ is determined according to the equation 0.05 TR₁≦TR₂≦0.6 TR₁, and, for the case TR₂≧TRA, the radius TR₂ is determined according to the equation 0.1 TR₁≦TR₂≦0.95 TR₁.

### INTRODUCTION AND BACKGROUND

The present invention pertains to a pneumatic vehicle tire of the radial type with a tread strip, which has a width defined as the tread width TW, which represents its maximal width in the ground contact area in the case of mounted, loaded and inflated tires, where, when viewed in cross section, the outer contour of the tread strip has at least three different radii over its width TW, of which the first radius TR₁ extends over an area encompassing the zenith of the tire, while an adjoining area on both sides of this area has a radius TR₂, which is smaller than the radius TR₁, and while on each side of this area an adjoining area has a radius TRA, which is smaller than the radius TR₁ of the area encompassing the zenith of the tire.

It is known that tires with their outer contour designed with only one radius, especially when these tires are provided with a low cross section, have a nonuniform pressure distribution in the ground contact area. Above all, the contact pressure is often elevated in the shoulder areas of such tires. This elevated contact pressure in the shoulder areas negatively affects not only tire noise but also other tire characteristics, such as braking behavior, stability at higher speeds, rolling resistance and the hydroplaning characteristics.

In order to solve this problem, it has already been proposed that the outer contour of the tire be designed with several variable radii in the area of the tread strip. It is known, e.g., that two radii can be provided with the one extending over the an area of the width of the tread strip encompassing the zenith of the tire and areas adjoining this on both sides and extending to the shoulder areas of the tire, which are provided with the second radius. Numerous patent applications pertain to the optimization of such a 2-radii contour, e.g., EP-A 0 269 301 proposes that the size of the radii be established in relation to the cross-sectional width of the tire. Here the one area of the outer contour encompassing the zenith of the tire is provided with a radius selected to be between 1.5 and 2.5 times the maximal width of the tire mounted on a rim and inflated; the second radius should be greater than the first radius, especially 1.5-2.5 times the first radius.

EP-B 0 323 519 also pertains to an equalization of the contact pressure of the tire in the ground contact area in order to prevent nonuniform wear and improve wet gripping and driving comfort. In this patent as well a 2-radii contour is selected for the outer contour of the tread strip and the arrangement of the sidewalls is set in certain relationships to the conditions existing between the running surface radii and the maximum tire width.

A pneumatic vehicle tire of the type described in the introduction, the outer contour of which is designed with three different radii is known from EP-A 0 850 788. Here, in addition to an optimization of the belted plies to reduce tire weight, improved tire performance and driving comfort is of concern. To this end, the outer contour of the tire in the tread strip area is combined with three different radii and with a variable number of belted plies.

With a 2-radii contour or a 3-radii contour, as known heretofore, it is indeed possible to achieve certain improvements in the pressure distribution in the ground contact area; however, even with complementary optimization of diverse parameters, it is not possible to influence the pressure distribution in the ground contact area of the tire to the desired extent or in desired manner.

Accordingly, an object of the invention, with a tire of the type described above and by way of optimization of the configuration of the outer contour of the tread strip area, is to increase the possibility of being able to control better than heretofore the pressure distribution in the ground contact area, in order to be able to influence deliberately certain characteristics of the tire, such as braking behavior, handling, noise development, and the like.

### SUMMARY OF INVENTION

The aforementioned and other objects can be achieved according to the invention in that in each case the margins of the tread strip defined by the tread width TW run in a fourth radius, a shoulder radius provided in the transition area to the sidewalls of the tire, so that the size of the radius TRA is derived according to the equation 0.05 TR₁≦TRA≦0.65 TR₁ in that the radius TR₂ is either less than or greater than the radius TRA, where, for the case when TR₂≦TRA, the size of the radius (TR₂) is defined by the equation 0.05 TR₁≦TR₂≦0.6 TR₁ and for the case when TR₂≧TRA, the size of the radius (TR₂) is defined by the equation 0.1 TR₁≦TR₂≦0.05 TR₁.

Consequently, according to the present invention the outer contour of the tread strip is so designed that it consists of an area with four different radii. This fundamentally permits a much better exercise of influence on the pressure distribution in the ground contact area. As has been shown, the interrelationship of the size of the individual radii is also significant for a equalization of the pressure distribution, especially the aforementioned relationship between the radius in the area encompassing the zenith of the tire and the radius of the radially outermost areas. Specifically, it is the last radius that makes it possible to exert influence on the volume in the shoulder areas outside the contact area. For example, with a relatively large radius in these areas a decrease of the volume in the shoulder areas outside the contact area is achieved. The rounder dynamic contour thus realized results in a lower temperature development in the tire and therefore an improved high-speed stability. The achievable uniformity of the pressure distribution has positive effects on various tire characteristics, such as braking behavior, handling and noise development.

In many cases of the structural design of a tire according to the invention, a uniform pressure distribution in the ground contact area can be realized when TR₂<TRA. However, depending upon the contour specifications and the structural configuration of the tire, other relationships and conditions for a uniform pressure distribution and an optimal diminution of the pressure in the shoulder areas can also be advantageous here and TR₂>TRA can prevail.

The desired rounder dynamic contour of the tire is especially well achieved when the size of the radius TRA is determined according to the equation 015≦TRA≦0.05 TR₁.

For the case when TR₂>TRA, it is especially advantageous if the size of TR₂ is determined according to the equation 0.6 TR₁≦TR₂≦0.95 TR₁.

For the desired characteristics improvement or the extent of the influence exercised on the pressure distribution in the ground contact area of the tire, it is important how the size of the individual radii is determined or selected. Specifically, the radius TR₁ should be determined according to the equation
3 TW≦TR₁≦25 TW, especially
3 TW≦TR₁≦6 TW.

The width of the areas with the three different radii also has a certain significance. In this respect, it is favorable when the area that includes the zenith of the tire with the radius TR₁, which is delimited by a distance TW₁ between two points that are symmetrical about the zenith of the tire, is so designed that TW₁ satisfies the equation 0.1 TW≦TW₁≦0.7 TW.

The area adjoining the zenith of the tire with the radius TR₂ extends especially to two points in the outer contour that are symmetrical about the zenith of the tire, the distance TW₂ between which points is determined by the equation 0.15 TW≦TW₂≦0.9 TW.

The transition to the shoulder radius on each side ensues at a distance (RA) from the edges of the tread strip, which is between 1.5 and 14%, especially between 3 and 10%, of the tread width TW.

### BRIEF DESCRIPTION OF INVENTION

Further characteristics, advantages and details of the invention are described at greater length with references to the appended drawings. The two figures of the drawing are schematic illustrations, where

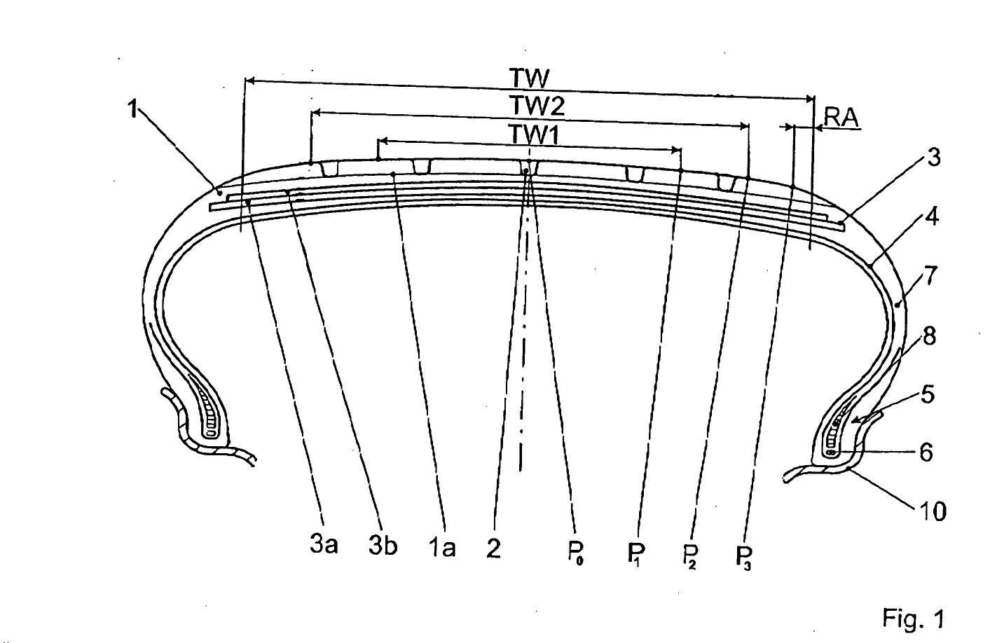

FIG. 1 depicts a cross section through a pneumatic vehicle tire designed according to the invention and

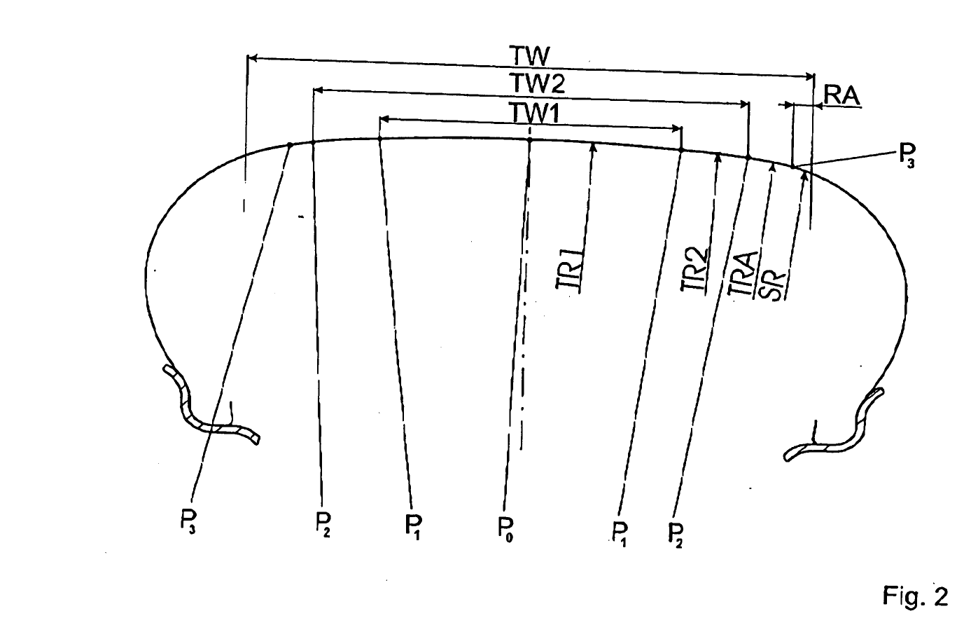

FIG. 2 depicts only the trace of the outer contour and the trace of the inner contour of the tire in FIG. 1.

### DETAILED DESCRIPTION OF INVENTION

The depicted and described embodiment example pertains to a tire for an automobile. The invention is not, however, restricted to this type of tire and can just as easily be applied to other types of tires, e.g., truck tires.

The pneumatic vehicle tire shown in FIG. 1 is mounted on a merely indicated rim 10 and includes a tread strip 1, which is provided with a tread pattern, on which peripheral grooves (2) are depicted. The tread strip 1 runs laterally into the shoulder areas of the tire and is therefore wider than the tread width TW shown in FIG. 1. The tread width TW is the greatest width of the tire imprint (also called the contact area) on the ground when the tire is mounted on a suitable rim and placed under nominal pressure and nominal load. The illustrated peripheral grooves (2) extend to the preplanned maximum profile depth, which in general is chosen to be 7-8 mm. Other profile structures, e.g., grooves running in the transverse direction, can also be provided, which, except for a trace becoming flatter into the shoulder areas, usually extend to the maximum profile depth. The groove base of these profile structures is delimited over the circumference of the tire by an envelope, of which the outline (1a) is shown in FIGS. 1 and 2 and which is described as the inner contour.

Provided radially inside the tread strip 1 is a belted band 3, which in the embodiment form shown in FIG. 1 has two ply layers 3a, 3b, of which the radially inner ply layer 3b is wider. The two ply layers 3a, 3b can be built up in the usual style and manner, e.g., consisting in each case of steel cords embedded in a rubber matrix and running parallel inside each layer. The complementary arrangement of both ply layers 3a, 3b or of the steed cords in the ply layers 3a, 3b is normally such that between the steel cords of the one layer and the steel cords of the other layer a crossed arrangement exists.

The tire shown by way of example in FIG. 1 is also provided with a single-layer radial carcass 4, which in both bead areas 5 extends from the inside outward over bead cores 6 and back into the sidewalls 7, where the carcass 4 ends in the sidewalls 7 in each instance at a separation from the upper end areas of the core profiles 8.

According to the present invention, the outer contour of the tire is specially designed in the tread strip area, especially in order that a uniform pressure distribution can be at least extensively achieved in the ground contact area of the tire. To this end, the outer contour encompasses areas with three different radii TR₁, TR₂ and TRA.

As is shown in FIG. 1 in conjunction with FIG. 2, the tire mounted on the rim 10 and inflated has in the tread strip an area encompassing the zenith of the tire, which is identified in the drawings by the point P₀, with the radius TR₁. This area extends on both sides from the point P₀ to the points P₁, which lie symmetrically to the point P₀. Thus the radius TR₁ extends over an area of the outer contour defined by the separation TW₁ between both points P₁. For TW₁ the equation (1) 0.1 TW≦TW₁≦0.7 TW applies.

The areas with the second radius TR₂ adjoin on both sides the area with the radius TR₁, where the transitions are selected to be not abrupt but rather gentle. The areas of the outer contour with the radius TR₂ extend on both sides between the points P₁ and the points P₂. The distance TW₂ between the two points P₂ is selected according to the equation (2) 0.15 TW≦TW₂≦0.9 TW.

The area with the third radius TRA is on both sides between the points P₂ and yet another point P₃ which in the outer contour of the tread strip defines the transition to a shoulder radius SR. The location of the points (P₃) is here axially inside the greatest tread width TW, indeed at a distance RA of 1.5-14% of the tread width TW.

Of special significance in achieving a uniform pressure distribution in the ground contact area of the tire is the complementary relationship of the radii TR₁, TR₂ and TRA. Especially applicable is TR₁>TR₂ and TRA<TR₁.

The value of TR₁ is determined by the following equation (3) 3 TW≦TR₁≦26 TW, especially 3 TW≦TR₁≦6 TW. For determining the value of TRA, the following equation is used (4) 0.05 TR₁≦TRA≦0.65 TR₁, especially 0.15 TR₁≦TRA≦0.65 TR₁. The value of TR₂ depends upon the other contour projections and the structural configuration of the tire, while the standard case thereof is TR₂≦TRA and TR₂≦TR₁, while the value of TR₂ can be determined by the equation (5) 0.05 TR₁≦TR₂≦0.6 TR₁.

In the case of certain projections, it is advantageous in achieving an optimal diminution of the pressure in the shoulder areas when TR₂>TRA and the value of TR₂ is selected according to the equation (6) 0.1 TR₁≦TR₂≦0.95 TR₁, especially 0.6 TR₁≦TR₂≦0.95 TR₁

In each instance, the outer contour is so configured that TRA≦TR₁. In order to reduce the pressure in the shoulder areas in order to achieve a uniform pressure distribution, TRA is nevertheless selected to be relatively great, so that the positive volume of the tread strip in the shoulder areas is also reduced outside the driving surface determined by the tread width TW. The rounder dynamic contour of the tread strip achievable according to the present invention also results in a lower temperature development during tire use. Due to the reduced shoulder pressure, high-speed stability is improved, as well as the durability of the tire. As already repeatedly noted, a uniform pressure distribution in the ground contact area of the tire is achieved with a design of the outer contour carried out according to the present invention. Just such a uniform pressure distribution has positive effects on the braking behavior, on the handling behavior and also on the noise development during operation.

Outer contours configured according to the present invention can also encompass more than three radii, where in the equations cited above, TRA is that radius that determines the contour of the two outermost areas. For example, an outer contour can consist of areas with four different radii.

The desired outer contour according to the invention is imparted to the tire by way of a comparable configuration of the inner contour of the segments of the vulcanization mold forming the tread strip area. The vulcanized tire mounted on a rim and inflated to a specified pressure has a congruous, at least essentially congruous, outer contour.

Further variations and modifications will be apparent to those skilled in the art from the foregoing and are intended to be encompassed by the claims appended hereto.

German application 195 45 774.3 is relied on and incorporated herein by reference.

1. Pneumatic vehicle tire with a tread strip, which has a width defined as the tread width TW, which represents its maximum width in the ground contact area in the case of mounted, loaded and inflated tires, where, when viewed in cross section, the outer contour of the tread strip has at least three different radii over its width TW, of which the first radius TR₁ extends over an area encompassing the zenith of the tire, while an adjoining area on both sides of this area has a radius TR₂, which is smaller than the radius TR₁, and while on each side of this area an adjoining area has a radius TRA, which is smaller than the radius TR₁ of the area encompassing the zenith of the tire, wherein each case the edges of the tread strip defined by the tread width TW run in an area with a fourth radius, a shoulder radius provided in the transition area to the sidewalls of the tire, in that the size of the radius TRA is determined according to the equation 0.05 TR₁≦TRA≦0.65 TR₁, in that the radius TR₂ is either smaller or greater than the radius TRA, where, for the case TR₂≦TRA, the size of the radius TR₂ is determined according to the equation 0.05 TR₁≦TR₂≦0.6 TR₁ and for the case TR₂>TRA, the size of the radius TR₂ is determined according to the equation 0.1 TR₁≦TR₂≦0.95 TR₁.

2. Pneumatic vehicle tire according to claim 1, wherein the radius TRA is determined according to the equation 015<TRA<TR₁.

3. Pneumatic vehicle tire according to claim 1 wherein for the case TR₂>RA the size of the radius TR₂ is determined according to the equation 0.6 TR₁≦TR₂≦0.95 TR₁.

4. Pneumatic vehicle tire according to claim 1, wherein the radius TR₁ is determined according to the equation 3 TW≦TR₁≦25 TW, especially according to the equation 3 TW≦TR₁≦6 TW.

5. Pneumatic vehicle tire according to claim 1 wherein the area with the radius TR₁ and encompassing the zenith of the tire is determined by a separation TW₁ between two points that are symmetrical about the zenith of the tire, where the separation TW₁ is determined according to the equation 0.1 TW≦TW₁≦0.7 TW.

6. Pneumatic vehicle tire according to claim 1, wherein each area with the radius TR₂ extends to two points in the outer contour that are symmetrical about the zenith of the tire, the distance TW₂ between which points is determined by the equation 0.15 TW≦TW₂≦0.9 TW.

7. Pneumatic vehicle tire according to claim 1, wherein each case the transition to the shoulder radius takes place at a distance RA from the edges of the tread strip, which is 1.5-14%, especially 3-10%, of the tread width TW.
